(19) United States
(12) Patent Application Publication
(10) Pub. No.: US 2010/0127833 A1
(43) Pub. Date: May 27, 2010

(54) IC TAG READING NECESSITY DETERMINATION METHOD, IC TAG READING NECESSITY DETERMINATION APPARATUS AND COMPUTER-READABLE MEDIUM STORING A PROGRAM

(75) Inventors: Hiroyasu SUGANO, Kawasaki (JP); Hideto Kihara, Kawasaki (JP); Kazuki Matsui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/606,563

(22) Filed: Oct. 27, 2009

(30) Foreign Application Priority Data
Nov. 21, 2008 (JP) 2008-298770

(51) Int. Cl. H04Q 5/22

(52) U.S. Cl. 340/10.1

(57) ABSTRACT

An IC-tag reading necessity determination method and system include preparing success rate information indicating a rate of success of receiving a response from an IC-tag to a first signal each time a set or a plurality of sets of transmitting the first signal to the IC-tag a plurality of times is performed, performing processing to transmit a second signal to a target IC-tag from a reading apparatus a plurality of times to acquire response reception success/failure information indicating success/failure of reception of a response to the second signal; and determining whether the target IC-tag is to be read based on the success/failure of each time indicated in the response reception success/failure information and a rate of success of each time indicated in the success rate information.

### CROSS-REFERENCE TO RELATED APPLICATIONS

This application is based upon and claims the benefit of priority of the prior Japanese Patent Application No. 2008-298770, filed on Nov. 21, 2008, the entire contents of which are incorporated herein by reference.

### BACKGROUND

1. Field

The embodiment(s) discussed herein are relates to a method, an apparatus that determines whether an IC tag is to be read.

2. Description of the Related Art

In recent years, RFID (Radio Frequency Identification) is widely used in various fields. Using the RFID, data including unique identification information stored in an IC (Integrated Circuit) tag can be read or data can be written into the IC tag by radio communication.

The types of IC tag are basically two types. One type of IC tag is an active IC tag that contains a battery to provide power to the IC tag itself. The other type is a passive IC tag that operates by receiving power from a high-frequency radio wave transmitted from a reader/writer apparatus. The passive IC tag does not contain any battery and is thus offered more cheaply than the active IC tag. Therefore, the passive IC tag is expected to be used in diverse areas including the field of physical distribution.

Several frequency bands are used for the RFID according to uses. If the band of UHF (Ultrahigh Frequency), that is, the band of 860 to 960 MHz is used as the frequency band, the reading range is wide even for a passive type when compared with other frequency bands and a plurality of tags can be read at a time. Thus, for example, in the field of physical distribution, a plurality of tags affixed to many articles can collectively be read to check articles.

However, if the reading range becomes wider, an IC tag not intended by the administrator may also be included in the reading range so that there is a possibility that unnecessary data is read.

If, for example, there is an IC tag of an article placed in a location usually apart from the gate so that the IC tag cannot be read when articles are stored in a warehouse or delivered from a warehouse, data may be read from the IC tag of the article because a radio wave is accidentally reflected by a forklift that happens to pass in the vicinity of the article and received. If a plurality of gates is placed side by side, data may be read from an IC tag of an article entering an adjacent gate.

To solve such problems, excluding data read from IC tags of irrelevant IDs by performing filtering based on IDs read from IC tags can be considered.

If, for example, IDs are hierarchically structured based on the type of article (whether a palette or individual article), filtering can be performed in accordance with which article data to be read concerns if the hierarchical structure thereof is known in advance.

A method of excluding data that cannot be read a specific number of times or more successively after attempting to read data a plurality of times concentratedly as accidentally read data is also well known (see, for example, Japanese Patent Application Laid-open No. 2005-275960).

### SUMMARY

An IC tag reading necessity determination method according to an embodiment of the present invention includes preparing success rate information indicating a sequence of success rates of receiving a response from an IC tag to a first signal of each time of transmitting the first signal to the IC tag for a set or a plurality of sets of times, transmitting a second signal to a target IC tag, which is an IC tag to be determined whether to be read, from a reading apparatus a plurality of times to acquire response reception result information indicating success/failure of reception of a response to the second signal each time in the reading apparatus, and determining whether the target IC tag is to be read based on the success/failure of each time indicated in the response reception result information and a success rate of each time indicated in the success rate information.

The determining preferably calculates a difference between a value of the success/failure indicated in the response reception result information, where the value 1 for the success and the value 0 for the failure are used, and the success rate indicated in the success rate information of each time and, when an average of the difference of each time exceeds a specific value, determines the determination target IC tag to be read and, when the difference is less than the specific value, determines the determination target IC tag not to be read.

The success rate information indicates a sequence of success rates of reception of a response to a signal when the signal whose transmission power is varied each time according to a specific pattern is used as the first signal and the processing of acquisition transmits the signal whose transmission power is varied each time according to the specific pattern as the second signal.

A signal indicating a search command to search for IDs of IC tags is used, for example, as the first signal and the second signal. The IC tag transmits the ID thereof on receiving the search command.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an example of an overall configuration of a storage/delivery management support system.

FIG. 2 illustrates an example of a hardware configuration of an IC tag reader/writer.

FIG. 3 illustrates an example of a hardware configuration of a management apparatus.

FIG. 4 illustrates an example of a functional configuration of a management apparatus.

FIG. 5 illustrates an example of an inventory database.

FIG. 6 illustrates an example of result(s) of reading IDs from IC tags.

FIGS. 7A and 7B illustrate examples of typical patterns of reading IDs.

FIG. 8 illustrates an example of smoothed reading results.

FIG. 9 illustrates an example of calculation results of similarity.

FIG. 10 is a flow chart of an overall flow of processing of a management apparatus.

FIG. 11 is a flow chart of the overall flow of processing of an IC tag reader/writer.

FIG. 12 illustrates an example of rates of success of reading IDs of IC tags.

FIG. 13 illustrates an example of calculation results of similarity.

FIG. 14 illustrates an example of typical patterns of reading IDs.

FIG. 15 illustrates an example of rates of success of reading IDs.

FIG. 16 is a flow chart of a modification of an overall flow of processing of a management apparatus.

FIG. 17 is a flow chart of a modification of an overall flow of processing of a management apparatus.

FIG. 18 is a flow chart of a modification of an overall flow of processing of an IC tag reader/writer.

FIGS. 19A and 19B illustrates examples of a matrix.

FIG. 20 illustrates an example of results of reading halfway through IDs.

FIG. 21 illustrates an example of calculation results of similarity.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

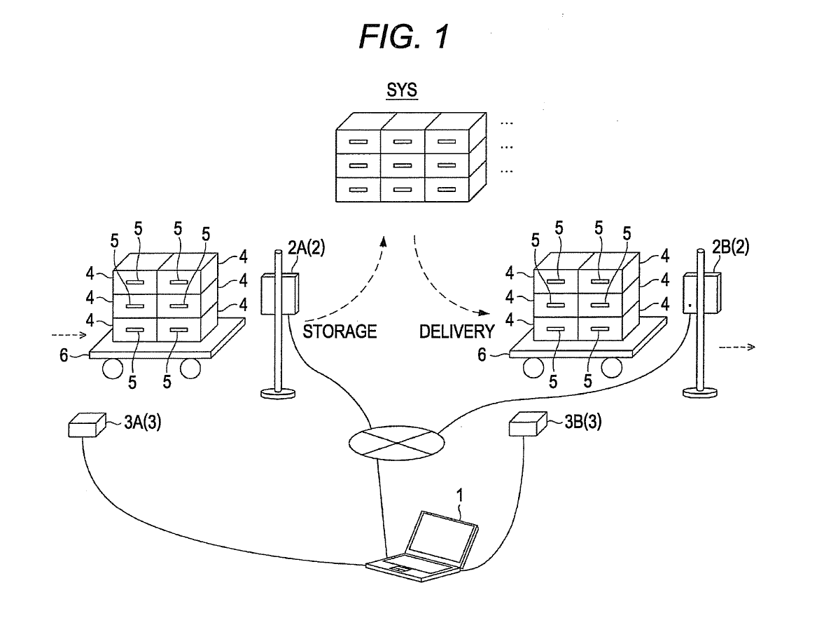

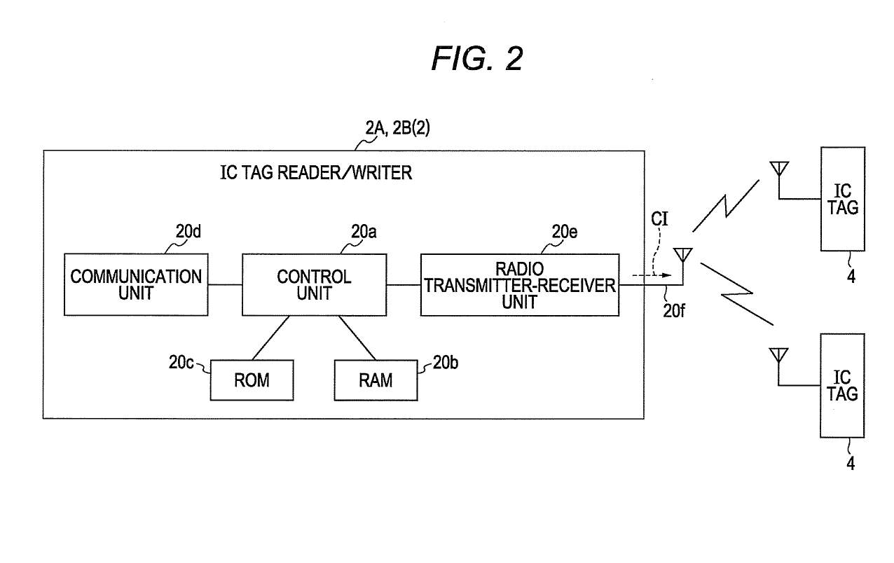

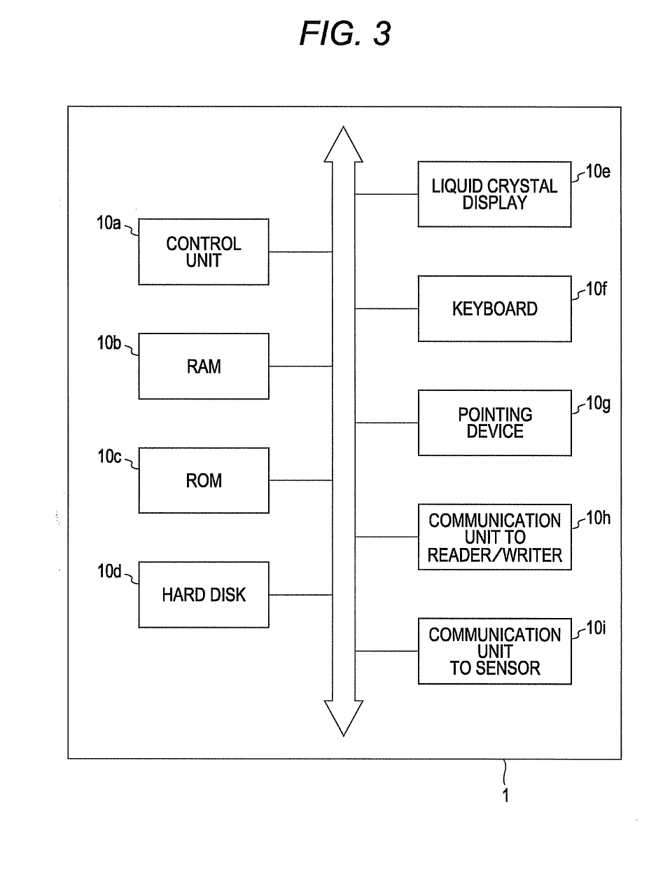

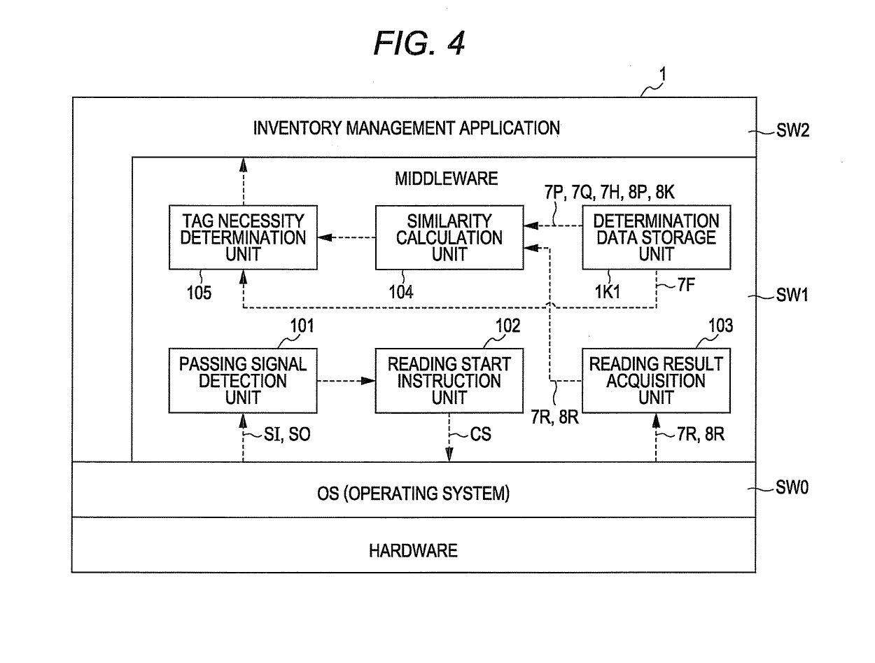

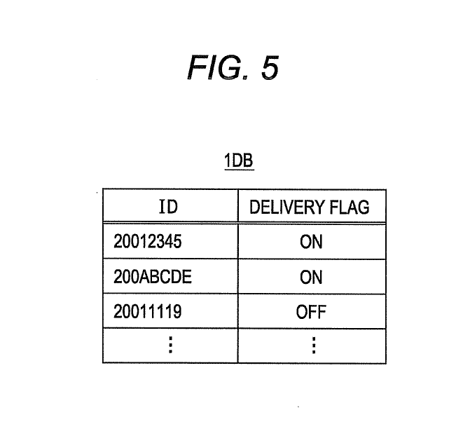

FIG. 1 illustrates an example of an overall configuration of a storage/delivery management support system SYS. FIG. 2 illustrates an example of a hardware configuration of an IC tag reader/writer 2. FIG. 3 illustrates an example of a hardware configuration of a management apparatus 1. FIG. 4 illustrates an example of a functional configuration of the management apparatus 1. FIG. 5 illustrates an example of an inventory database 1DB.

The storage/delivery management support system SYS is a system to support management of articles such as, for example, presence/absence of baggage (that is, the inventory) in a warehouse or the like. As illustrated in FIG. 1, the storage/delivery management support system SYS includes the management apparatus 1, the IC (Integrated Circuit) tag reader/writer 2, and a passage sensor 3. An example in which the storage/delivery management support system SYS is used in a warehouse X in a relay point to relay baggage shipped from various parts of the country to its destination will be described below.

The baggage is contained in any one of containers (palettes or cases) 4 in accordance with the receiver or destination. One or a plurality of the containers 4 is put on a cart 6 to be stored or delivered.

One IC tag 5 is affixed to one container 4. The IC tag 5 has a unique ID (Identifier) stored therein. In an embodiment, a passive IC tag is used as the IC tag 5.

The IC tag reader/writer 2 is an apparatus that reads data from the IC tag 5 or writes data to the IC tag 5. One unit of the IC tag reader/writer 2 is set up in the vicinity of each of an entering gate and a delivery gate of the warehouse X.

As illustrated in FIG. 2, the IC tag reader/writer 2 includes a control unit 20a, a RAM (Random Access Memory) 20b, a ROM (Read Only Memory) 20c, a communication unit 20d, a radio transmitter-receiver unit 20e, and one or more antenna 20f. Components illustrated in FIG. 2 are mutually connected via a bus or the like.

The ROM 20c stores information such as a program to control each component of the IC tag reader/writer 2 to read data from the IC tag 5.

The RAM 20b is an SRAM (Static RAM), flash memory or the like. The program stored in the ROM 20c is read into the RAM 20b when appropriate. In addition, the RAM 20b has data necessary for execution of the program and data (read data and various parameters) generated by execution of the program temporarily stored therein.

The control unit 20a is a CPU (Central Processing Unit), MPU (Micro Processing Unit) or the like and executes the program read by the RAM 20b. If the control unit 20a is an MPU, the RAM 20b and the ROM 20c may be incorporated into the control unit 20a.

The communication unit 20d is an apparatus that performs communication with the management apparatus 1 via a network. Particularly, as described in detail below, the communication unit 20d is used to receive a command from the management apparatus 1 or to transmit data read from the IC tag 5 to the management apparatus 1. An apparatus of a wired or wireless LAN (Local Area Network) is used as the communication unit 20d. Or, an apparatus with the interface such as USB (Universal Serial Bus) or IEEE (Institute of Electrical and Electronics Engineer) 1394 may also be used.

The radio transmitter-receiver unit 20e is an apparatus that transmits a command to the IC tag 5 and receives a response to the command by radio. Particularly, in an embodiment, the radio transmitter-receiver unit 20e is used to transmit a search command to read the ID from the IC tag 5 and to receive a response to the search command. The ID is read from the IC tag 5 in the following manner.

The radio transmitter-receiver unit 20e transmits the search command to inventory the IC tags 5 present in a range in which communication by the antenna 20f can be performed. When the IC tag 5 receives a radio wave including the search command, a current is generated in the IC tag 5, a voltage is supplied to each part of the IC tag 5, and the ID of the IC tag 5 is transmitted as a response to the search command. Then, the radio transmitter-receiver unit 20e receives the ID transmitted from the IC tag 5 via the antenna 20f.

If a plurality of the IC tags 5 is present within a range in which communication can be performed via the antenna 20f, these IC tags 5 transmit responses (that is, IDs) to the search command almost simultaneously. In this case, a collision situation in which the radio transmitter-receiver unit 20e cannot receive responses from the IC tags 5 may arise due to interference of respective responses. To avoid such a situation, various collision arbitration functions are implemented in the radio transmitter-receiver unit 20e and the IC tags 5.

An IC tag reader/writer and an IC tag in the communication frequency band of, for example, 860-960 MHz are used as the IC tag reader/writer 2 and the IC tag 5.

Returning to FIG. 1, the management apparatus 1 is an apparatus to manage data on conditions of presence/absence of baggage (that is, the stock) in the warehouse X in a unified fashion and is set up, for example, in the department of management.

As illustrated in FIG. 3, the management apparatus 1 includes a control unit 10a, a RAM 10b, a ROM 10c, a hard disk 10d, a display 10e, a keyboard 10f, a pointing device 10g, a communication unit to reader/writer 10h, and a communication unit to sensor 10i. Components illustrated in FIG. 3 are mutually connected by a bus or the like.

As illustrated in FIG. 4, the ROM 10c or the hard disk 10d has software such as an operating system SW0, middleware SW1, and an inventory management application SW2 stored therein.

The operating system SW0 manages the whole system of the management apparatus 1. The operating system SW0 also provides a basic user interface and drivers.

The middleware SW1 is software to distinguish IDs that are necessary from those that are not necessary among IDs read by the IC tag reader/writer 2 from the IC tag 5. The middleware SW1 implements functions such as a passing signal detection unit 101, a reading start instruction unit 102, a reading result acquisition unit 103, a similarity calculation unit 104, a tag necessity determination unit 105, and a determination data storage unit 1K1.

The inventory management application SW2 manages the inventory database 1DB, as illustrated in FIG. 5, indicating condition(s) of the container 4 stored in the warehouse X. Details of the inventory database 1DB are described in detail below.

Each module contained in the above-described software is read into the RAM 10b when necessary before being executed by the control unit 10a.

Similar to the control unit 20a of the IC tag reader/writer 2, the control unit 10a includes a CPU, MPU or the like. Similar to the RAM 20b of the IC tag reader/writer 2, the RAM 10b is an SRAM, flash memory or the like.

In the display 10e, in addition to a screen indicating conditions of the container 4, a screen indicating operation conditions of the management apparatus 1, an input screen of commands or data, and a screen indicating information of which the operator should be notified are displayed.

The keyboard 10f and the pointing device 10g are input devices used by the user to input a command or data to the management apparatus 1.

The communication unit to reader/writer 10h is an apparatus to perform communication with the IC tag reader/writer 2 via a network. An apparatus of a wired or wireless LAN is used as the communication unit to reader/writer 10h. Or, an apparatus with the interface such as USB or IEEE 1394 may also be used.

The communication unit to sensor 10i is an apparatus to perform communication with the passage sensor 3. An apparatus with the interface such as USB or IEEE 1394 is used as the communication unit to sensor 10i.

If the interface for communication with the IC tag reader/writer 2 and that for communication with the passage sensor 3 are the same, one device may be shared as the communication unit to reader/writer 10h and the communication unit to sensor 10i.

A personal computer, workstation, host computer or the like is used as the management apparatus 1.

Returning to FIG. 1, the passage sensor 3 is set up in the vicinity of each of the entering gate and the delivery gate of the warehouse X. The passage sensor 3 set up in the vicinity of the entering gate detects that the cart 6 passes through the entering gate and transmits a storage signal SI (FIG. 3) to the management apparatus 1. On the other hand, the passage sensor 3 set up in the vicinity of the delivery gate detects that the cart 6 passes through the delivery gate and transmits a delivery signal SO (FIG. 3) to the management apparatus 1. An optical sensor such as an infrared ray sensor or an ultrasonic sensor is used as the passage sensor 3.

The IC tag reader/writer 2 set up in the vicinity of the entering gate and the IC tag reader/writer 2 set up in the vicinity of the delivery gate may be distinguished and denoted as an “IC tag reader/writer 2A” and an “IC tag reader/writer 2B” respectively. Similarly, the passage sensor 3 set up in the vicinity of the storage gate and the passage sensor 3 set up in the vicinity of the delivery gate may be distinguished and denoted as a “passage sensor 3A” and a “passage sensor 3B” respectively.

The IC tag reader/writer 2A and the passage sensor 3A are arranged in such a way that the passage sensor 3A detects the cart 6 before the IC tag reader/writer 2A detects the container 4 when the cart 6 having the container 4 put thereon is stored in the warehouse. Similarly, the IC tag reader/writer 2B and the passage sensor 3B are arranged in such a way that the passage sensor 3B detects the cart 6 before the IC tag reader/writer 2B detects the container 4 when the cart 6 having the container 4 put thereon is delivered from the warehouse.

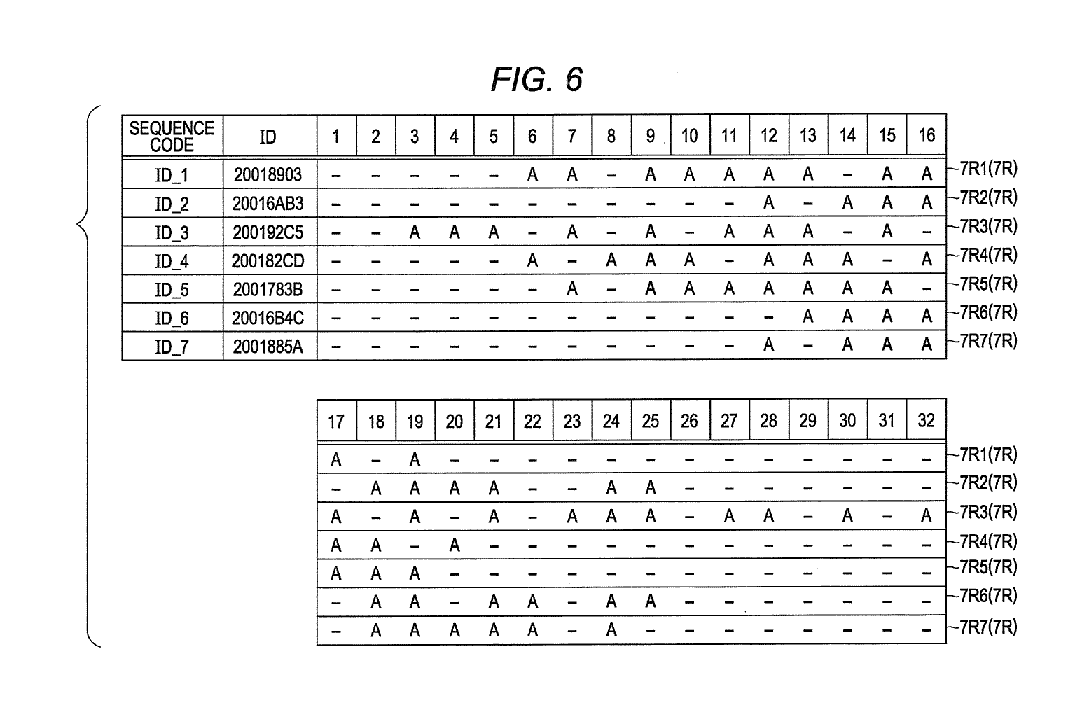

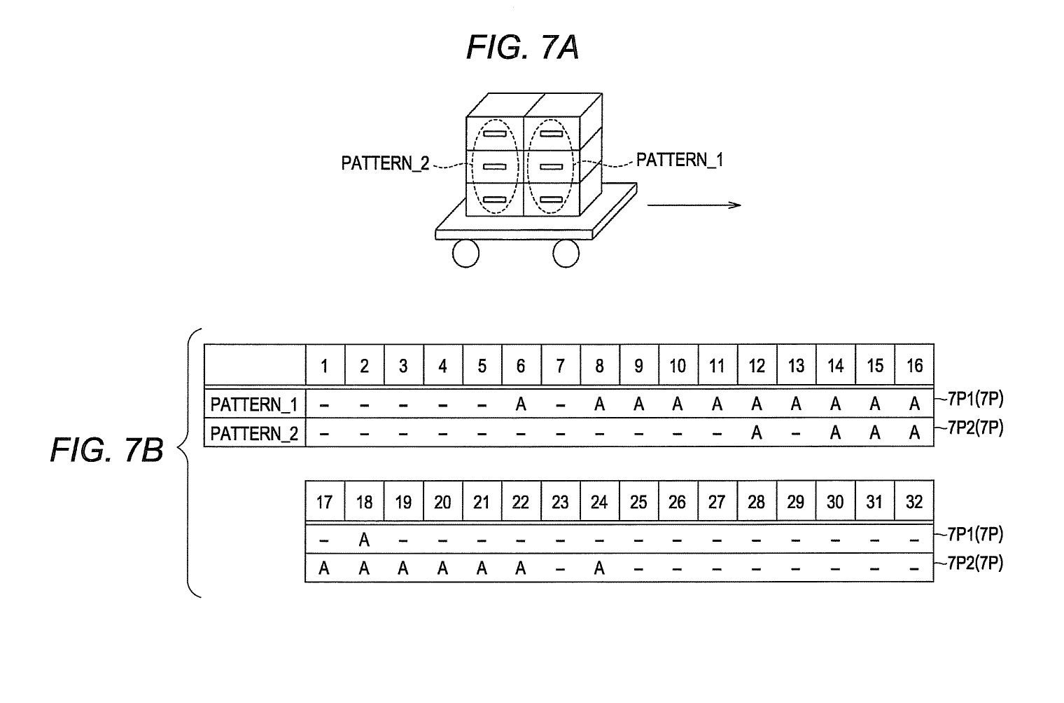

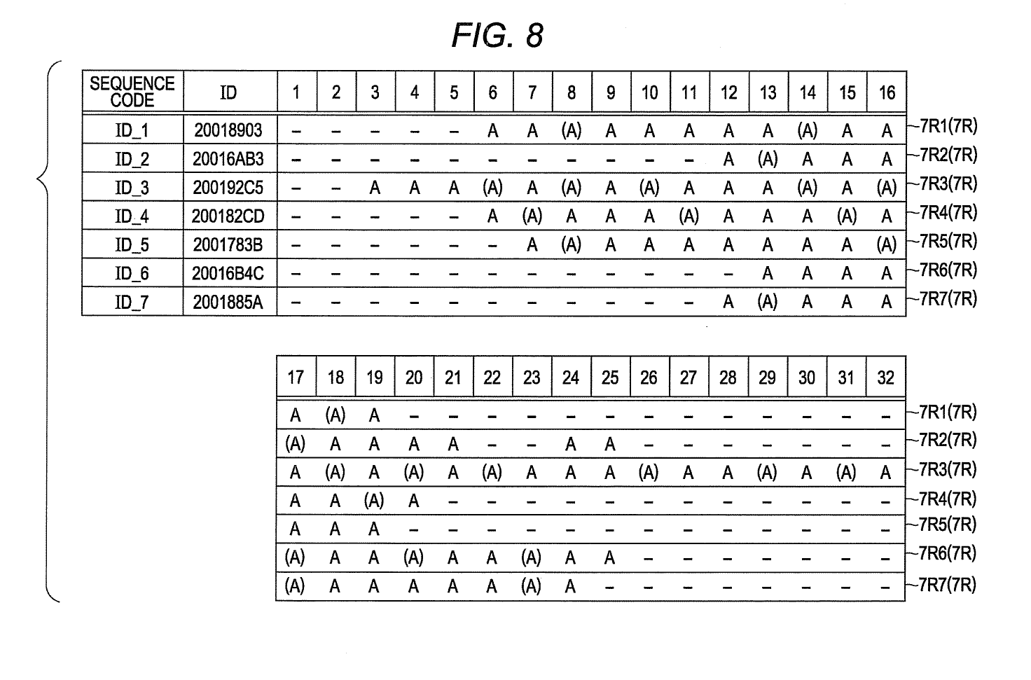

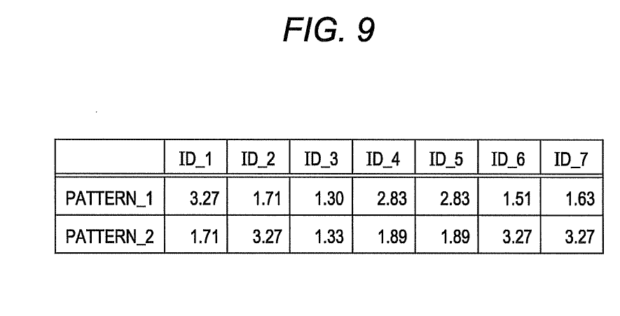

FIG. 6 illustrates an example of results of reading IDs from the IC tags 5. FIG. 7 illustrates examples of patterns of reading IDs. FIG. 8 illustrates an example of smoothed reading results. FIG. 9 illustrates an example of calculation results of similarity.

Next, each component of the management apparatus 1 illustrated in FIG. 4, each component of the IC tag reader/writer 2 illustrated in FIG. 2, and processing content of the passage sensor 3 is described in detail by taking a case in which the container 4 is stored in the warehouse X as an example.

When the cart 6 having the containers 4 put thereon passes through the entering gate, the passage sensor 3A first detects the cart 6. After the cart 6 is detected, the passage sensor 3A transmits a storage signal SI to the management apparatus 1.

In FIG. 4, the passing signal detection unit 101 detects the storage signal SI transmitted from the passage sensor 3A.

After the storage signal SI is detected by the passing signal detection unit 101, the reading start instruction unit 102 transmits a start command CS instructing a start of reading the ID of the IC tag 5 to the IC tag reader/writer 2A.

Incidentally, if the passing signal detection unit 101 detects a delivery signal SO transmitted from the passage sensor 3B, the reading start instruction unit 102 transmits the start command CS to the IC tag reader/writer 2B.

In FIG. 2, when the communication unit 20d of the IC tag reader/writer 2A receives the start command CS, the control unit 20a controls the radio transmitter-receiver unit 20e so that reading of the ID of the IC tag 5 is started.

The radio transmitter-receiver unit 20e repeatedly transmits a radio wave of the search command (hereinafter, denoted as a search command CI) during a specific time (hereinafter, denoted as a “reading time Tr”) at fixed transmission power (for example, 27 dBm) and at the specific time intervals.

After passing through the entering gate and being detected by the passage sensor 3A, the cart 6 gradually approaches the IC tag reader/writer 2A and passes in front of the IC tag reader/writer 2A before moving away from the IC tag reader/writer 2A. Thus, the IC tag 5 put on the cart 6 gradually changes from a state in which it is difficult for the IC tag reader/writer 2A to receive the response of the search command CI from the IC tag 5 to a state in which it is easy for the IC tag reader/writer 2A to receive the response of the search command CI from the IC tag 5 before passing in front of the IC tag reader/writer 2A. Further, after passing in front of the IC tag reader/writer 2A, the IC tag 5 put on the cart 6 gradually changes to a state in which it is difficult for the IC tag reader/writer 2A to receive the response of the search command CI from the IC tag 5. Therefore, radio transmitter-receiver unit 20e gradually changes from a state in which it is difficult to read the ID to a state in which it is easy to read the ID before the cart 6 passes in front of the IC tag reader/writer 2A and, after the cart 6 passes in front of the IC tag reader/writer 2A, radio transmitter-receiver unit 20e gradually changes to a state in which it is difficult to read the ID.

The search command CI may reach the IC tag 5 of the container 4 put on other cart 6 or the IC tag 5 of the container 4 already in the warehouse (that is, the IC tags 5 of the untargeted containers 4), and the IDs of the IC tags 5 of the untargeted containers 4 may reach the IC tag reader/writer 2A.

Because of the above characteristics, the radio transmitter-receiver unit 20e repeatedly transmits the search command CI to acquire reading results, as illustrated in FIG. 6, in which the number of the read tag IDs near the center of the reading time Tr is higher than that at the start or at the end of the reading time Tr and the total number of read IDs is larger than the number of the containers 4 put on the cart 6. Due to limited space, reading result data 7R is illustrated by being divided into two in FIG. 6. This also applies to FIGS. 7B, 8, 12, 14, and 15 illustrated in detail below.

In FIG. 6, “Reading sequence number” indicates the position in a sequence of reading (transmission of the search command CI) after some start command CS is received. In the example of FIG. 6, the search command CI is transmitted 32 times during the reading time Tr. Thus, the control unit 20a issues the reading sequence numbers “1” to “32”.

The control unit 20a generates one row of the reading result data 7R for each ID of the IC tag 5 read by the radio transmitter-receiver unit 20e at least once during the reading time Tr. The reading result data 7R contains, in addition to the ID of the read IC tag 5, conveniently attached sequence codes. Further, the reading result data 7R contains results of reading the ID of the IC tag 5 of each reading sequence number. In FIG. 6, values indicating reading results are “A” and “-”. “A” indicates that the ID of the IC tag 5 could be read (succeeded in reading). “-” indicates that the ID of the IC tag 5 could not be read (failed in reading).

The reading result data 7R of IDs of the IC tags 5 obtained by the radio transmitter-receiver unit 20e is transmitted to the management apparatus 1 by the communication unit 20d under the control of the control unit 20a.

The reading result acquisition unit 103 of the management apparatus 1 acquires the reading result data 7R from the IC tag reader/writer 2.

The determination data storage unit 1K1 has data used for similarity calculation by the similarity calculation unit 104 described below in detail and for necessity determination of ID of the IC tag 5 by the tag necessity determination unit 105 stored therein. The above data will successively be described in detail below.

A general usage of IC tags produces a typical pattern of reading results for an ID of some IC tag 5 in the reading time Tr. Such a typical pattern is acquired by a typical use of IC tag reading in advance, for example, causing the cart 6 having the container 4 put thereon to pass through the entering gate under a normal condition and causing the IC tag reader/writer 2A to perform reading processing of IDs of the IC tags 5 as described above before starting an operation of the storage/delivery management support system SYS. While a particular way of obtaining a pattern for reading of the ID is discussed herein, the present invention is not limited to any particular way of capturing reading result pattern.

For example, as illustrated in FIG. 7A, the cart 6 having a total of six containers 4 with two rows in the direction of movement, three rows in the direction of height, and one row in the direction of width put thereon is caused to enter the warehouse. As a result, two typical patterns illustrated, for example, in FIG. 7B are obtained.

Then, pattern data 7P indicating an obtained pattern is generated and stored in the determination data storage unit 1K1. If a plurality of typical patterns is obtained, the pattern data 7P is generated and stored for each typical pattern.

The similarity calculation unit 104 calculates a degree of similarity (hereinafter, denoted as the “similarity”) between a pattern indicated in the reading result data 7R acquired from the IC tag reader/writer 2 and that indicated in the pattern data 7P by using Equation (1) as below:

$$Equation 1$$

$$SimilarityS ( a , b ) = 1 / D ( a , b ) \\ where \\ Equation 2 \\ Distance D ( a , b ) = \sqrt{\{ {\sum }_{k = 1}^{n} {( a\_k - b\_k )}^{2} \} / n} \\ and \\ Equation 3 \\ \begin{matrix}a = \{ \begin{matrix}a \_ {1}_{,} & a \_ {2}_{,} & … & a\_n\end{matrix} \} \\ b = \{ \begin{matrix}b \_ {1}_{,} & b \_ {2}_{,} & … & b\_n\end{matrix} \}\end{matrix} \qquad ( 1 )$$

“a_k” is a value, “1” or “0”, indicating success/failure of the k-th reading indicated in the reading result data 7R, where “1” indicates success and “0” a failure. Similarly, “b_k” is a value, “1” or “0”, indicating success/failure of the k-th reading indicated in the pattern data 7P, where “1” indicates success and “0” a failure. “n” is the number of times of reading. In the example of FIGS. 6 and 7B, “n=32”.

For example, a similarity between reading result data 7R1 in FIG. 6 and pattern data 7P1 is calculated from

a={0,0,0,0,0,1,1,0,1,1,1,1,1,0,1,1,1,0,1,0,0,0,0,0,0,0,0,0,0,0,0,0}b={0,0,0,0,0,1,0,1,1,1,1,1,1,1,1,1,0,1,0,0,0,0,0,0,0,0,0,0,0,0,0,0} Equation 3

as “2.309”.

Considering the possibility that the ID may become instantaneously unreadable for some reason in an environment in which the state of radio waves becomes unstable, the similarity calculation unit 104 may make smoothing corrections of the reading result data 7R before calculating similarities between the reading result data 7R after being corrected and the pattern data 7P.

The limit number of times of failure (that is, a number of successive failures) between successful readings of ID is determined in advance under which reading results therebetween are considered to be successful. The determination data storage unit 1 K1 stores the smoothing parameter 7H indicating the number of times. Then, the similarity calculation unit 104 makes smoothing corrections of the reading result data 7R based on the smoothing parameter 7H.

If, for example, “1” is indicated by the smoothing parameter 7H, each piece of the reading result data 7R in FIG. 6 is corrected as illustrated in FIG. 8. “(A)” indicates locations where the result is corrected from a failure to success.

When the similarity calculation unit 104 calculates similarities between patterns indicated in the reading result data 7R (7R1, 7R2, . . . , 7R7) after being corrected in FIG. 8 and those indicated in the pattern data 7P (7P1, 7P2) in FIG. 7B, results illustrated in FIG. 9 are obtained.

The tag necessity determination unit 105 determines whether the ID of the read IC tag 5 is necessary or not. This also applies below where reading by the IC tag reader/writer 2 is determined to be necessary based on a similarity calculated by the similarity calculation unit 104 in the following way.

The tag necessity determination unit 105 compares a similarity between the pattern indicated in the reading result data 7R and that indicated in the pattern data 7P to a filtering threshold. If the similarity between the pattern indicated in the reading result data 7R and that indicated in the pattern data 7P is smaller than or equal to the filtering threshold, the tag necessity determination unit 105 determines that the ID related to the reading result data 7R is unnecessary. On the other hand, if the similarity between the pattern indicated in the reading result data 7R and that indicated in the pattern data 7P is greater than the filtering threshold, the tag necessity determination unit 105 determines that the ID related to the reading result data 7R is necessary.

If there is a plurality of pieces of the pattern data 7P, the tag necessity determination unit 105 makes a determination in the following way. The tag necessity determination unit 105 compares a similarity between the pattern indicated in the reading result data 7R and that indicated in the first piece of the pattern data 7P to a filtering threshold. If the similarity between the pattern indicted in the reading result data 7R and that indicated in the first piece of the pattern data 7P exceeds the filtering threshold, the ID of the IC tag 5 related to the reading result data 7R is made to belong to a typical pattern, or a cluster, related to the first piece of the pattern data 7P. For the second and subsequent pieces of the pattern data 7P, the tag necessity determination unit 105 similarly compares the similarity between the pattern indicated in the reading result data 7R and that indicated in the N-th piece of the pattern data 7P to the filtering threshold. If the similarity between the pattern indicated in the reading result data 7R and that indicated in the N-th piece of the pattern data 7P exceeds the filtering threshold, the ID of the IC tag 5 is clustered to typical patterns related to the N-th piece of the pattern data 7P

Then, the ID of the IC tag 5 clustered to any one of typical patterns is determined to be necessary. The ID of the IC tag 5 clustered to none of typical patterns is determined to be unnecessary.

The filtering threshold is decided in advance and filtering data 7F indicating the filtering threshold is stored in the determination data storage unit 1K1.

If, for example, similarities are calculated as illustrated in FIG. 9 and the filtering threshold is “2.8”, ID_1, ID_4, and ID_5 are clustered (grouped) to Pattern_1 and ID_2, ID_6, and ID_7 to Pattern_2. Thus, these six IDs are determined to be necessary. ID_3 is clustered to none of typical patterns and thus, ID_3 is determined to be unnecessary.

Determination results obtained by the tag necessity determination unit 105 are used by the inventory management application SW2. In the above example, necessity of IDs of the IC tags 5 detected in the vicinity of the entering gate is determined by the tag necessity determination unit 105 and thus, IDs of the IC tags 5 determined to be necessary relate to the containers 4 newly stored in the warehouse X. Thus, the inventory management application SW2 newly adds records of IDs of the IC tags 5 determined to be necessary to the inventory database 1DB in FIG. 5.

“Delivery flag” of a record indicates whether the container 4 related to the record is delivered. The default value thereof is “Off”.

Necessity of IDs of the IC tags 5 read by the IC tag reader/writer 2 (2B) of the delivery gate is also determined in the same manner. Then, the inventory management application SW2 updates the delivery flag of records of IDs of the IC tags 5 determined to be necessary of IDs of the IC tags 5 read by the IC tag reader/writer 2B to “On”.

Pattern data of typical patterns for the delivery gate to compare with reading patterns of IDs of the IC tags 5 read by the IC tag reader/writer 2B may be prepared separately from pattern data for the entering gate (the pattern data 7P in FIG. 7B). That is, pattern data of typical patterns for delivery may be prepared based on patterns obtained by the IC tag reader/writer 2B in the vicinity of the delivery gate in advance so as to determine whether IDs are necessary by using the prepared pattern data of typical patterns for delivery.

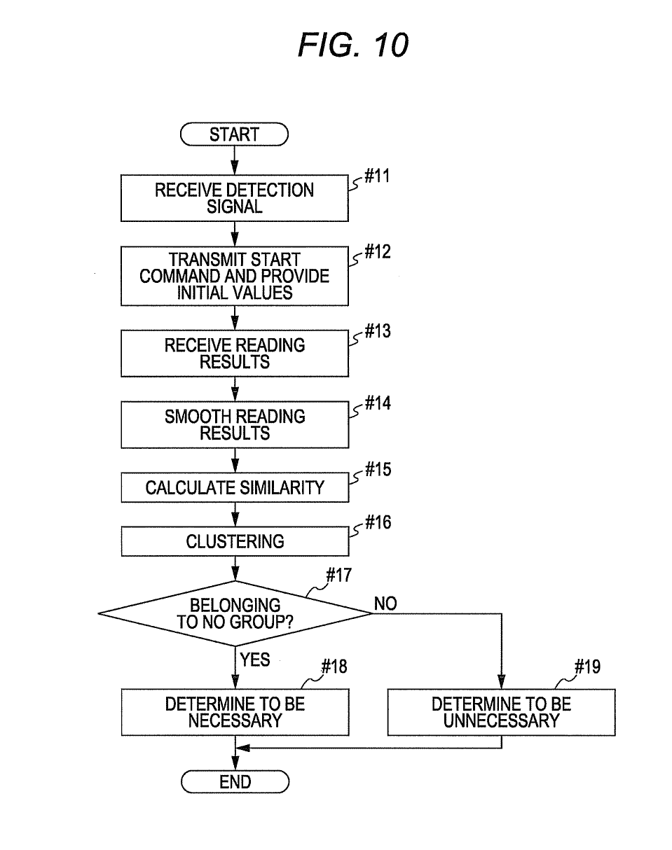

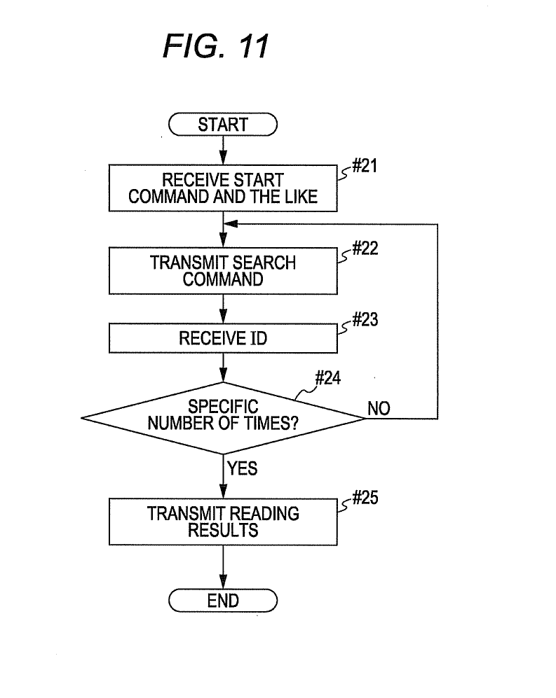

FIG. 10 is a flow chart of an example of an overall flow of processing of the management apparatus 1. FIG. 11 is a flow chart of an example of the overall flow of processing of the IC tag reader/writer 2.

Next, the overall flow of processing of the management apparatus 1 and the IC tag reader/writer 2 when one cart 6A having several units of the containers 4 put thereon is stored in the warehouse X is described with reference to the flow charts in FIGS. 10 and 11.

When the passage sensor 3A detects the cart 6A, a storage signal SI is transmitted from the passage sensor 3A to the management apparatus 1.

After receiving the storage signal SI (#11 in FIG. 10), the management apparatus 1 transmits a start command CS to the IC tag reader/writer 2A (#12). At this point, the management apparatus 1 transmits values of various parameters used for the reading processing of the IC tag 5 (such as a time during which reading should be executed (reading time Tr), an initial value of a counter of a number of times of executed reading (normally “0”), and a time interval between execution of reading) to the IC tag reader/writer 2A together with the start command CS. Or, values of various parameters may be preset in the IC tag reader/writer 2A.

After receiving the start command CS or the like (#21 in FIG. 11), the IC tag reader/writer 2A attempts to read IDs from the IC tags 5 of the containers 4 put on the cart 6A by transmitting the search command CI at specific time intervals during the reading time Tr based on various parameters contained in the start command CS or the like (#22, #23). Then, after IDs of the IC tags 5 are read for the specific reading time Tr (Yes at #24), the IC tag reader/writer 2A transmits the reading result data 7R of each ID of the IC tag 5 that was read at least once, as illustrated in FIG. 6, to the management apparatus 1 (#24).

After receiving the reading result data 7R from the IC tag reader/writer 2A (#13 in FIG. 10), the management apparatus 1 smoothes patterns indicated in the reading result data 7R as illustrated in FIG. 8 based on the smoothing parameter 7H (#14).

A similarity between a pattern indicated in each piece of the reading result data 7R after smoothing and that indicated in each piece of the pattern data 7P (see FIG. 7B) is calculated (#15). The ID of each piece of the reading result data 7R is clustered depending on a comparison of each similarity with the filtering threshold indicated in the filtering data 7F (#16).

Then, IDs of the IC tags 5 that could not be classified into any of typical patterns are determined to be unnecessary (Yes at #17, #18) and IDs of the IC tags 5 that could be classified into at least one of typical patterns are determined to be necessary (No at #17, #19).

According to this embodiment, whether the IC tag 5 is to be read or not can be determined more reliably than in the past. Accordingly, necessity of data read from the IC tag 5 can be determined more reliably than in the past.

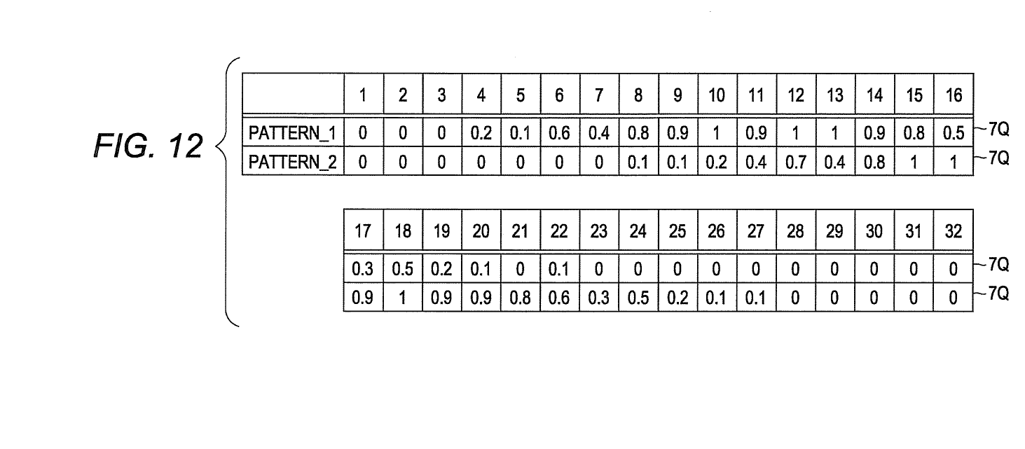

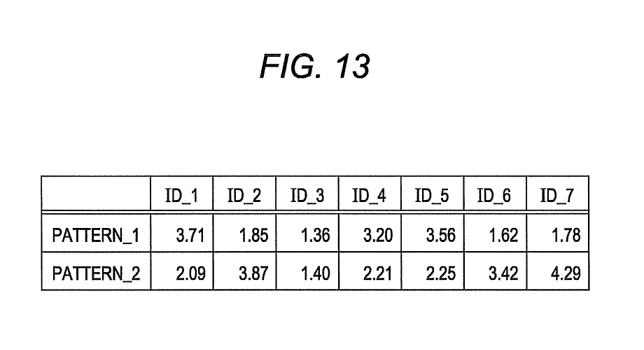

FIG. 12 illustrates an example of success rates of reading IDs of the IC tags 5. FIG. 13 illustrates an example of calculation results of similarity.

In the above example, pattern data indicating patterns of success/failure of reading as illustrated in FIG. 7B is used as the pattern data 7P, but pattern data 7Q as illustrated in FIG. 12 may also be used. The pattern data 7Q is generated in the following manner before being stored in the determination data storage unit 1K1.

Similar to a case where the pattern data 7P is generated, the cart 6 having the container 4 put thereon is caused to pass through the entering gate under a normal condition in advance to cause the IC tag reader/writer 2 to perform reading processing of IDs before starting an operation of the storage/delivery management support system SYS. In the present modification, however, the IC tag reader/writer 2 is caused to perform the reading processing a plurality of times (for example, several tens of times).

The number of times of successful reading of each ID is counted for each reading sequence number. The ratio of the number of times of successful reading to the number of times of executed reading of the ID of each of the IC tags 5 (that is, the rate of success) is calculated for each reading sequence number. Then, the pattern data 7Q indicating a success rates for each reading sequence number is generated for each ID of the IC tag 5.

The method of calculating a similarity when the pattern data 7Q is used is the same as that of calculating a similarity when the pattern data 7P is used. That is, the similarity calculation unit 104 calculates a similarity of ID of each of the IC tags 5 based on Equation (1).

If, for example, the reading result data 7R (7R1, 7R2, . . . , 7R7) illustrated in FIG. 8 is obtained and similarities are calculated using the pattern data 7Q illustrated in FIG. 12, results illustrated in FIG. 13 are obtained. Further, if the filtering threshold indicated in the filtering data 7F is “3.0”, ID_1, ID_4, and ID_5 are classified into Pattern_1 and ID_2, ID_6, and ID_7 to Pattern_2. Then, these six IDs are determined to be necessary. ID_3 is classified into none of patterns and thus, ID_3 is determined to be unnecessary.

In the above embodiment(s), repeated transmission of the search command is controlled by the IC tag reader/writer 2, but an embodiment in which a reading command is repeatedly issued by the management apparatus 1 in a specific time or until specific conditions are met and the IC tag reader/writer 2 transmits the search command in response to the received reading command before returning a result thereof each time to the management apparatus 1 can also be considered.

Moreover, an embodiment in which calculation of the similarity to the reading data 7R and classification of whether the read data of the IC tag 5 is necessary, which are performed by the management apparatus 1, are performed by the IC tag reader/writer 2 can also be considered. In this case, it is necessary to provide instructions of parameters such as the filtering threshold and smoothing parameter to the IC tag reader/writer 2 in advance or each time.

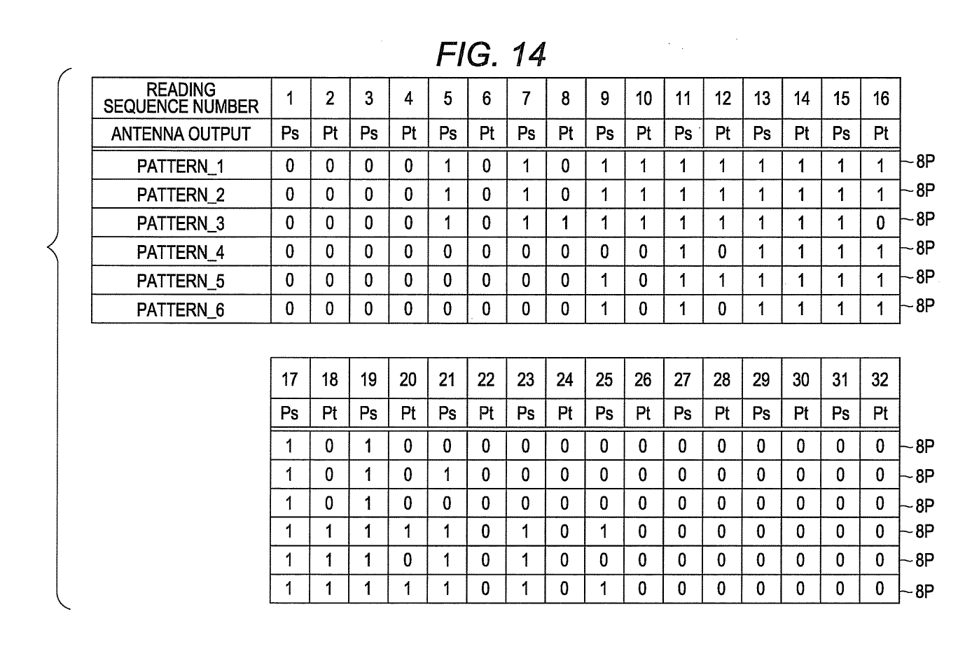

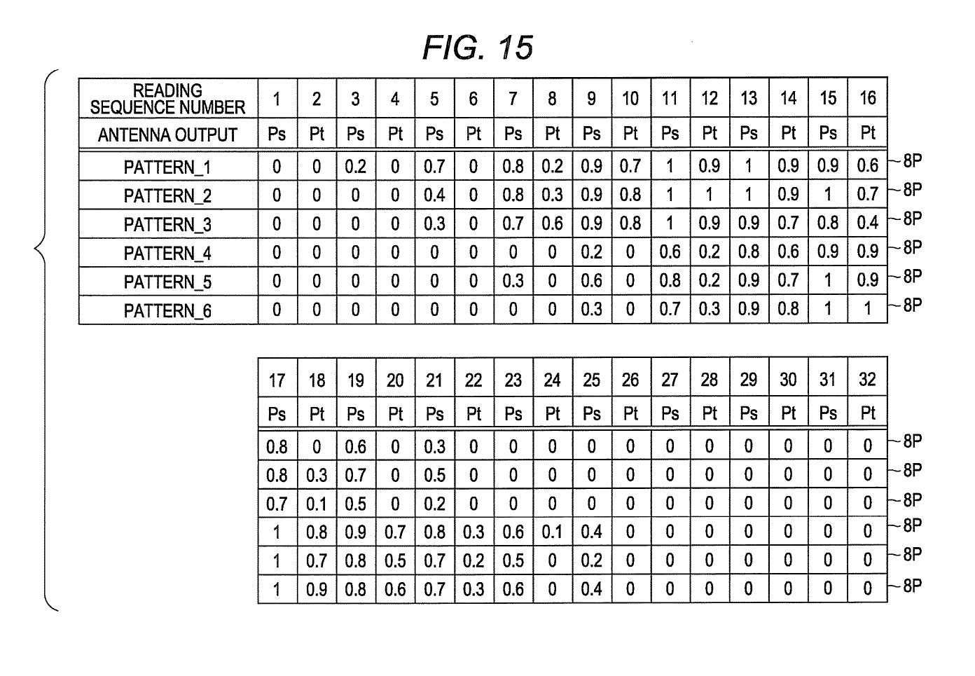

FIG. 14 illustrates an example of typical patterns of reading IDs. FIG. 15 illustrates an example of rates of success of reading IDs.

While the radio transmitter-receiver unit 20e transmits the search command CI by a radio wave at fixed transmission power in an embodiment, the radio transmitter-receiver unit 20e transmits the search command CI with varying transmission power of radio wave in another embodiment.

The overall configuration of the storage/delivery management support system SYS in this embodiment is the same as that in the embodiment discussed above and as illustrated in FIG. 1. The hardware configuration, functional configuration and overall procedures of processing of the management apparatus 1, the IC tag reader/writer 2, and the passage sensor 3 are basically the same as those in the above-described embodiment and as described with reference to FIGS. 2, 3, 4, 10, and 11.

In an embodiment, however, as described above, the search command CI is output while the transmission power of radio wave is changed. Thus, an output control unit to change the transmission power of radio wave is provided in the IC tag reader/writer 2. In addition, similarities are calculated by assigning weights to reading results in accordance with the transmission power of radio wave.

Processing content of each unit in an embodiment will be described by focusing on differences from the above-described embodiment. A description of an embodiment common to that of the above-described embodiment is omitted.

Similar to a case in the above-described embodiment, after receiving a storage signal SI from the passage sensor 3A, the management apparatus 1 transmits a start command CS to the IC tag reader/writer 2A. Or, when a delivery signal SO is received from the passage sensor 3B, the management apparatus 1 transmits the start command CS to the IC tag reader/writer 2B.

In the IC tag reader/writer 2, when the start command CS is received from the management apparatus 1, the radio transmitter-receiver unit 20e repeatedly transmits the search command CI at specific time intervals by a radio wave of transmission power Ps or Pt (for example, Ps=27 dBm and Pt=20 dBm) for the reading time Tr. For example, the search command CI is transmitted at the transmission power Ps for odd-numbered transmission and at the transmission power Pt for even-numbered transmission.

Then, similar to the above-described embodiment, the communication unit 20d transmits reading result data (hereinafter, denoted as “reading result data 8R” to distinguish from the reading result data 7R in the above-described embodiment) of IDs read at least once to the management apparatus 1.

In the management apparatus 1, instead of the pattern data 7P illustrated in FIG. 7B or FIG. 12, pattern data 8P as illustrated in FIG. 14 or FIG. 15 is stored in the determination data storage unit 1K1.

The pattern data 8P is obtained in the same way as the pattern data 7P. That is, a typical pattern is acquired by causing the cart 6 having the container 4 put thereon to pass through the entering gate under a normal condition in advance and causing the IC tag reader/writer 2A to perform reading processing of IDs of the IC tags 5 before starting an operation of the storage/delivery management support system SYS. However, in contrast to the above-identified embodiment, the radio transmitter-receiver unit 20e transmits the search command CI in a pattern of varying transmission power like during operation.

Then, the pattern data 8P indicating a trend of the pattern of obtained reading results is generated and the determination data storage unit 1K1 is caused to store the pattern data 8P. If a plurality of typical patterns is obtained, the pattern data 8P is generated and stored for each typical pattern.

Instead of Equation (1), the similarity calculation unit 104 (see FIG. 4) uses a following Equation (2) to calculate a similarity between a pattern indicated in each piece of the reading result data 8R received from the IC tag reader/writer 2 and that indicated in each piece of the pattern data 8P.

$$Equation 1$$

$$\begin{matrix}{SimilarityS}_{2} ( c , d ) = 1 / {D}_{2} ( c , d ) \\ where \\ Equation 2 & ( 2 ) \\ Distance {D}_{2} ( c , d ) = \sqrt{\{ {\sum }_{k = 1}^{n} w\_k {( c\_k - d\_k )}^{2} \} / n} \\ and \\ Equation 3 \\ \begin{matrix}c = \{ \begin{matrix}c \_ {1}_{,} & c \_ {2}_{,} & … & c\_n\end{matrix} \} \\ d = \{ \begin{matrix}d \_ {1}_{,} & d \_ {2}_{,} & … & d\_n\end{matrix} \}\end{matrix} & ( 3 )\end{matrix}$$

Similar to a_k in the above-identified embodiment, “c_k” is a value indicating success/failure of the k-th reading indicated in the reading result data 8R. Similarly, “d_k” is a value indicating success/failure of the k-th reading indicated in the pattern data 8P or the rate of success. “n” is the number of times of reading. “w_k” is a weighting factor associated with transmission power for the k-th reading. A larger weighting factor is set to smaller transmission power. For example, “1” and “1.5” are set as the weighting factors of the transmission power Ps and the transmission power Pt respectively. Weighting factor data 8K indicating these weighting factors is stored in the determination data storage unit 1K1.

According to an embodiment, primary importance is attached to reading results by a weak radio wave. Thus, whether the IC tag 5 is to be read can be determined more reliably than in the above-identified embodiment.

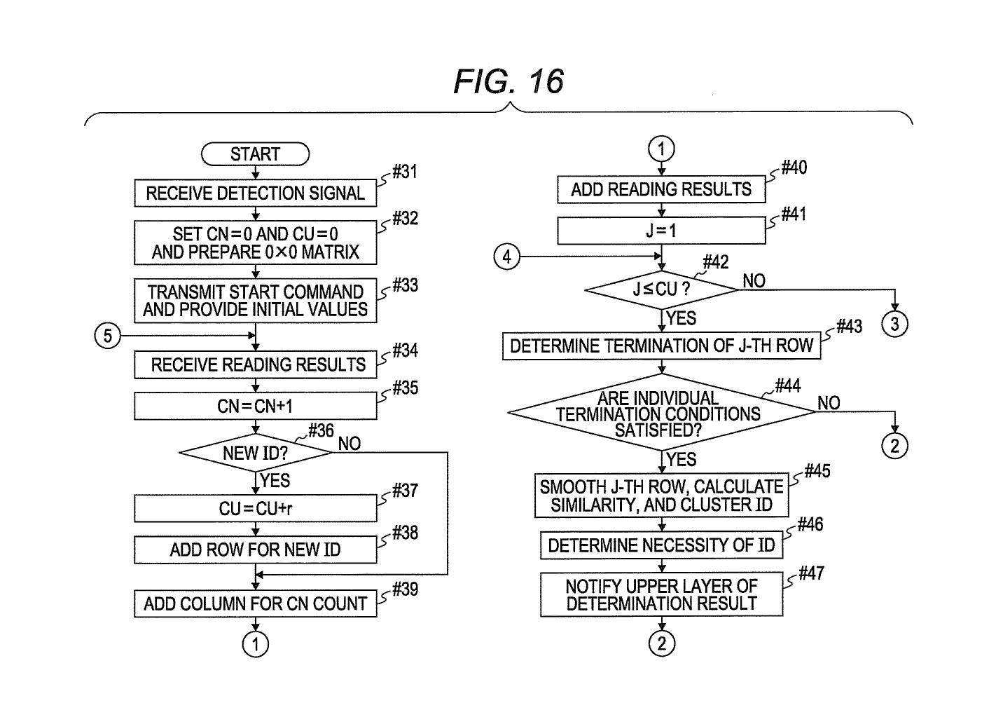

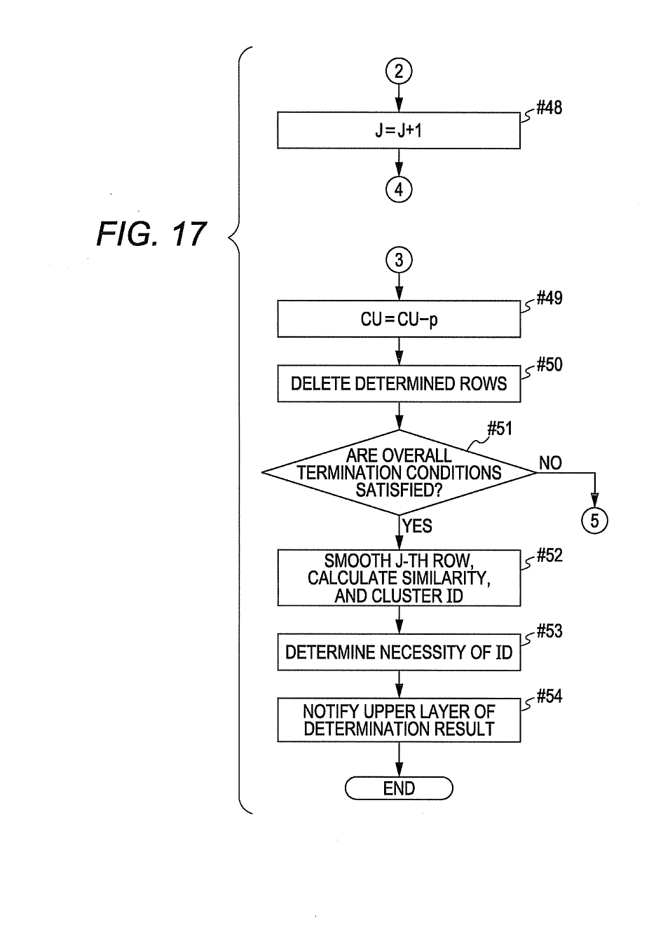

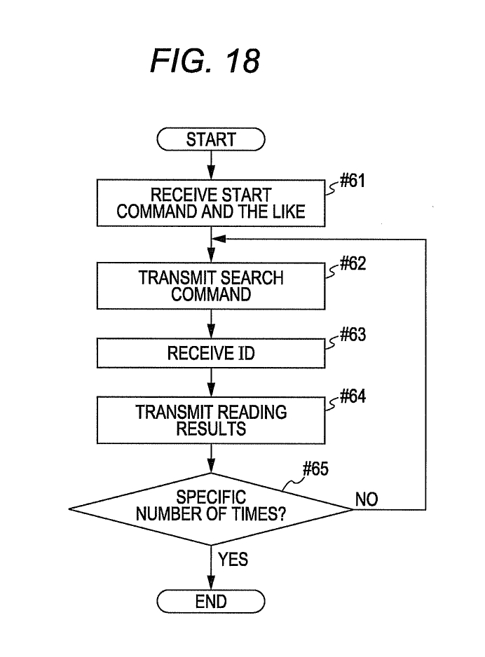

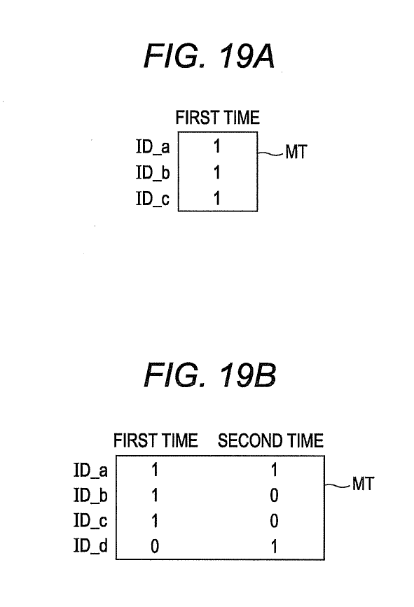

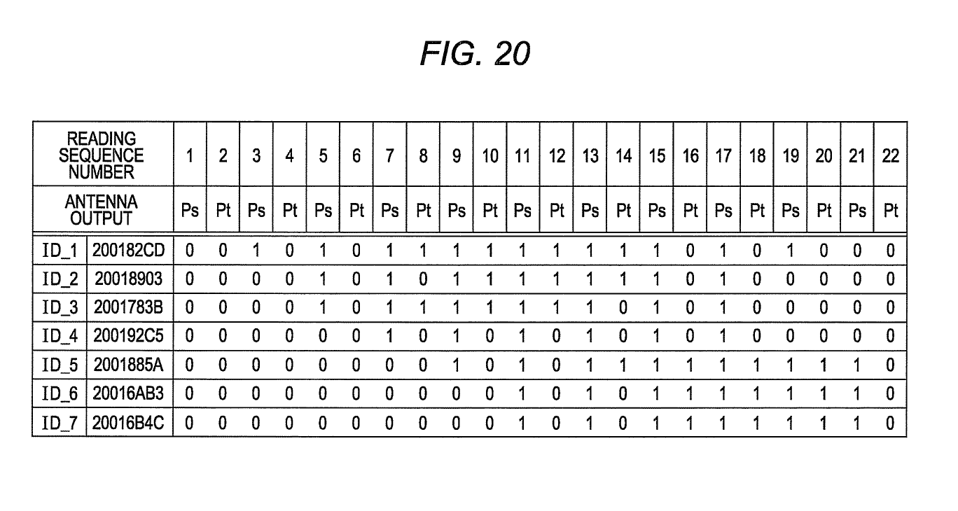

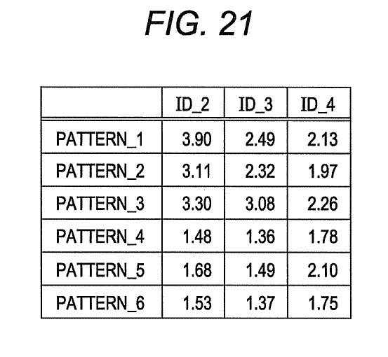

FIGS. 16 and 17 are flow charts of an overall flow of processing of the management apparatus 1. FIG. 18 is a flow chart of the overall flow of processing of the IC tag reader/writer 2. FIGS. 19A and 19B illustrate examples of a matrix MT. FIG. 20 illustrates an example of results of reading halfway through IDs. FIG. 21 illustrates an example of calculation results of similarity.

While similarities are calculated and necessity is determined after all reading results for the specific time (reading time Tr) are obtained in the above embodiments, similarity calculation and necessity determination may be performed based on reading results obtained halfway through the reading time Tr. For example, the management apparatus 1 and the IC tag reader/writer 2 may be caused to operate as illustrated in FIGS. 16, 17, and 18.

For example, when the storage signal SI is received from the passage sensor 3A (#31 in FIG. 16), the management apparatus 1 performs processing to acquire the ID of the container 4 being stored in the following way. The matrix MT to store reading results of IDs by the passage sensor 3A, a counter CN to count the number of times of reading, and a counter CU to count IDs whose necessity is not determined are prepared (#32). The matrix MT is 0x0 at this point, but rows and columns thereof will increase in accordance with results of reading IDs. The initial value of the counters CN and CU is “0” for both.

The management apparatus 1 transmits the start command CS to the IC tag reader/writer 2A (#33). The management apparatus 1 may transmit values of various parameters together.

After receiving the start command CS or the like (#61 in FIG. 18), the IC tag reader/writer 2A attempts to read IDs from the IC tags 5 by transmitting the search command CI only the specific number of times while varying transmission power of the radio wave by the same method as described above (#62, #63). However, timing to transmit reading results to the management apparatus 1 is different from that of the above method. That is, instead of transmitting reading results for a total number of times of reading together, IDs that could be read each time reading is attempted are transmitted together with information indicating the transmission power of an output radio wave, the number of times of attempted reading and the like (#64).

After receiving reading results from the IC tag reader/writer 2A (#34 in FIG. 16), the management apparatus 1 adds “1” to the counter CN (#35). If any ID (new ID) read for the first time by the IC tag reader/writer 2A is contained (Yes at #36), the number of new IDs is added to the counter CU (#37) and also rows for the new IDs are added to the matrix MT (#38).

The management apparatus 1 adds a column to store reading results of the count indicated by the counter CN to the matrix MT (#39). The management apparatus 1 also stores to which ID each row corresponds. Then, the management apparatus 1 writes reading results of each ID to the matrix MT (#40).

If, for example, first reading results are transmitted and the reading results indicates three IDs (ID_a, ID_b, and ID_c), as illustrated in FIG. 19A, the management apparatus 1 adds three rows to the matrix MT and further adds one column. Then, the management apparatus 1 writes the value “1” indicating that these three IDs have successfully been read into the matrix MT.

If second reading results transmitted thereafter indicates two IDs of “ID_a” and “ID_d”, as illustrated in FIG. 19B, the management apparatus 1 adds a row of ID_d, which is a new ID, to the matrix MT and further adds one column. Then, the management apparatus 1 writes to the matrix MT that these two IDs have successfully been read. A value “0” indicating a failure of reading is written into blank fields.

Based on reading results obtained up to this point, the management apparatus 1 determines necessity of each ID read up to this point (#41 to #46). The determination method is the same as described above.

That is, reading results indicated in the row of the first ID are smoothed, a similarity between a pattern of the smoothed reading results and a typical pattern is calculated, and clustering is performed based on the similarity (#45). Then, IDs that could be clustered are determined to be necessary and those that could not be clustered to be unnecessary.

Here, data indicated in rows of the matrix MT is used as the reading result data 8R. The current value of the counter CN is substituted into n in Equation (3).

Or, necessity of only IDs satisfying specific conditions may be determined (#44). For example, necessity of only IDs that have unsuccessfully been attempted to read a specific number of times (for example, four times) successively or more by going back from the present time may be determined.

For example, if reading results up to the 22nd reading are as illustrated in FIG. 20 and pattern data 8P in FIG. 15 are used to calculate similarities, results as illustrated in FIG. 21 are obtained.

Then, the management apparatus 1 provides determination results of necessity of IDs to the inventory management application SW2 and the like (#47). Necessity of IDs related to remaining rows of the matrix MT is similarly determined (#43 to #48 in FIG. 17).

After necessity is determined based on the matrix MT at the present time, the number of IDs whose determination is completed is subtracted from the counter CU (#49) and the row of each ID is deleted from the matrix MT (#50).

If overall termination conditions are met, for example, when last reading results have been received (Yes at #51), necessity is determined based on reading results of the total number of times of reading (#52 to #54). If the termination conditions are not met (No at #51), the above processing is performed by returning to step #34 in FIG. 16.

If the start command CS is once received from the management apparatus 1, the IC tag reader/writer 2 autonomously transmits the search command CI at transmission power and time intervals indicated by parameters in the embodiment(s), but the transmission power and time interval may fully be instructed by the management apparatus 1.

Passive IC tags are used in the embodiment(s), but the present invention can also be applied when active IC tags are used.

A general-purpose computer such as a personal computer may be used as the management apparatus 1 in the embodiment(s), but a special-purpose computer may also be used. In such a case, the management apparatus 1 may transmit determination results of necessity to a personal computer that needs determination results.

The IC tag reader/writer 2A reads only IDs from the IC tags 5 in the embodiment(s), but information such as the type of article, manufacturing date, shipper, or shipment destination may thereafter be read from the IC tags 5 having IDs determined to be necessary by the management apparatus 1.

The embodiment(s) are described by taking inventory management of the container 4 having baggage put thereon as an example, but the present invention can also be applied for other purposes. For example, the present invention can be applied to management of entry/exit of persons into/from facilities.

Processing results of pattern matching can be used not only for determination of necessity of IDs, but also for estimation of the position of the container 4 on the cart 6. That is, the container 4 can be estimated to be put in a position corresponding to a typical pattern having the highest level of similarity to the pattern of reading results of the ID of the container 4.

Considering fluctuation (s) in speed of movement of the cart 6, the reading result data 7R (or 8R) and the pattern data 7P (or 8P) may be corrected so that the center of reading result patterns and that of typical patterns are aligned in a specific position on the path of storage or delivery.

The transmission power of radio wave is set to have two levels in an embodiment, but the number of levels may be three or more. Different weighting factors are set depending on the transmission power of radio wave, but the same weighting factor may be used.

The function of the management apparatus 1 and that of the IC tag reader/writer 2 may be put together in one apparatus.

In addition, the whole configuration of the storage/delivery management support system SYS, the management apparatus 1, and IC tag reader/writer 2 or the configuration of each component, processing content, order of processing, configuration of data and the like may be modified when appropriate without departing from the spirit of the present invention.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. An IC tag reading necessity determination method, comprising:
preparing success rate information indicating a sequence of success rates of receiving a response from an IC tag to a first signal each time of transmitting the first signal to the IC tag for a set or a plurality of sets of times;
transmitting a second signal to a target IC tag, which is to be determined whether to be read, from a reading apparatus a plurality of times to acquire response reception result information indicating success/failure of reception of a response to the second signal each time in the reading apparatus; and
determining whether the target IC tag is to be read based on the success/failure of each time indicated in the response reception result information and a success rate of each time indicated in the success rate information.

2. An IC tag reading necessity determination method according to claim 1,
wherein the determining calculates a difference between a value of the success/failure indicated in the response reception result information, where the value 1 for the success and the value 0 for the failure are used, and the success rate indicated in the success rate information of each time
and, when an average of a difference of each time exceeds a specific value, determines the target IC tag is to be read and, when the difference is less than the specific value, determines the target IC tag is not to be read.

3. An IC tag reading necessity determination method according to claim 1,
wherein the success rate information indicates a sequence of success rates of reception of a response to a signal when the signal whose transmission power is varied each time according to a specific pattern is used as the first signal; and
the signal whose transmission power is varied each time according to the specific pattern is transmitted as the second signal.

4. An IC tag reading necessity determination method according to claim 1,
wherein the determining includes determining whether the target IC tag is to be read by assigning greater weights to the difference of the success/failure indicated in the response reception result information and the success rate indicated in the success rate information of the times corresponding to the first signal or the second signal with weaker transmission power.

5. An IC tag reading necessity determination apparatus, comprising:
a success rate information storage unit that stores success rate information indicating a sequence of success rates of receiving a response from an IC tag to a first signal each time of sets of transmitting the first signal to the IC tag for a set or a plurality of sets of times;
a reading control unit that controls a reading apparatus to transmit a second signal to a target IC tag a plurality of times, and to receive a response to the second signal each time; and
a determination unit that determines whether the target IC tag is to be read based on success/failure of reception of the response of each time by the reading apparatus and a success rate of each time indicated in the success rate information.

6. An IC tag reading necessity determination apparatus according to claim 5,
wherein the reading control unit controls the reading apparatus so that the second signal is transmitted for a specific time; and
wherein the determination unit determines whether the target IC tag is to be read based on the success/failure halfway through the specific time.

7. A computer-readable storage medium storing a program causing a computer to execute an operation, comprising:
acquiring success rate information indicating a sequence of success rates of receiving a response from an IC tag to a first signal each time of transmitting the first signal to the IC tag for a set or a plurality of sets of times;
controlling a reading apparatus to cause the reading apparatus to transmit a second signal to a target IC tag a plurality of times, and to cause the reading apparatus to receive a response to the second signal each time; and
determining whether the target IC tag is to be read based on success/failure of reception of the response of each time by the reading apparatus and a success rate of each time indicated in the success rate information.

8. A computer-implemented method of determining whether an IC tag needs to be read, comprising:
determining whether a threshold is satisfied based on a result of a similarity comparison between stored reading pattern of the IC tag, where the stored reading pattern of the IC tag is a rate of success of reading the IC tag each time a signal is transmitted to the IC tag; and
indicating that the IC tag needs to be read when the threshold is satisfied.
